(19) United States
(12) Patent Application Publication
(10) Pub. No.: US 2017/0084895 A1
(43) Pub. Date: Mar. 23, 2017

(54) FILM PRODUCING METHOD AND FILM PRODUCING APPARATUS

(71) Applicant: Sumitomo Chemical Company, Limited, Tokyo (JP)

(72) Inventors: Jian WANG, Daegu (KR); Yusuke KON, Ehime (JP)

(21) Appl. No.: 15/264,676

(22) Filed: Sep. 14, 2016

(30) Foreign Application Priority Data
Sep. 18, 2015 (JP) 2015-185646

(51) Int. Cl. H01M 2/14; B26D 5/00; B26D 7/26; H01M 10/0525; H01M 10/42

(52) U.S. Cl. CPC H01M 2/145; H01M 10/0525; H01M 10/4235; B26D 7/2628; B26D 5/007

(57) ABSTRACT

An aspect of the present invention includes a slitting step of a battery separator original sheet lengthwise, the battery separator original sheet being conveyed lengthwise, to form a plurality of heat-resistant separators, the slitting step including a determining step of determining the widthwise dimension or widthwise position of the separator original sheet being conveyed.

This Nonprovisional application, claims priority under 35 U.S.C. §119 on Patent Application No. 2015-185646 filed in Japan on Sep. 18, 2015, the entire contents of which, are hereby incorporated by reference.

### TECHNICAL FIELD

The present invention relates to a film producing method and a film producing apparatus.

### BACKGROUND ART

There has been known a deficiency inspecting device for a sheet-shaped product including an optical film (Patent Literature 1). The deficiency inspecting device receives information on a deficiency from a protective film inspecting section, and forms a data code (for example, a two-dimensional code or a QR Code [registered trademark]) having a fixed pitch and indicative of the deficiency. The deficiency inspecting device forms such a data code on a surface at an end of a PVA

film original sheet together with information on the position and production identification.

### CITATION LIST

### Patent Literature

### Patent Literature 1

Japanese Patent Application Publication, Tokukai, No. 2008-116437 A (Publication Date: May 22, 2008)

### SUMMARY OF INVENTION

### Technical Problem

Production of a separator for use in a lithium ion secondary battery, for example, suffers from a defect in a separator original sheet. Enormous efforts are expended to specify the position of such a defect in a separator original sheet.

A typical conventional production process includes (i) a defect detecting step of detecting a defect in a separator original sheet with use of a defect detecting device while conveying the separator original sheet and recording the position of the defect and (ii) a subsequent slitting step of conveying the separator original sheet to a cutting device and cutting (slitting) the separator original sheet with use of a cutting device for a product width. The production process thus produces a plurality of separators from a single separator original sheet.

In a case where a separator original sheet is cut while being conveyed on a conveying device, however, the width wise position of the separator original sheet is changed depending on (i) the position of the separator original sheet on the conveying device, (ii) meandering or deformation of the separator original sheet conveyed, and (iii) tension applied to the separator original sheet by the conveying device. Such a change may displace cutting positions for a separator original sheet from intended cutting positions.

The above phenomenon makes it difficult to identify which of a plurality of separators prepared by slitting a separator original sheet has the defect present therein. In particular, the closer the defect is to any intended slit line, the higher the risk of a wrong separator being erroneously identified as the separator having the defect present therein.

It is an object of the present invention, to provide a film producing method and a film producing apparatus each of which can, in a ease where a film original sheet is slit into a plurality of films, accurately specify the correspondence between a position on a film original sheet and a film.

### Solution to Problem

In order to solve the above problem, a film producing method in accordance with the present invention is a film producing method, including: a slitting step of slitting a film original sheet lengthwise, the film original sheet being conveyed lengthwise, to form a plurality of films, the slitting step including a determining step of determining a widthwise dimension or a widthwise position of the film original sheet being conveyed.

In order to solve the above problem, a film producing apparatus in accordance with the present invention is a film producing apparatus, including a cutting section configured to slit a film original sheet lengthwise, the film original sheet being conveyed lengthwise, to form a plurality films, the cutting section including a determining section configured to determine a widthwise dimension and a widthwise position of the film original sheet being conveyed to the cutting section.

### Advantageous Effects of Invention

The present invention, in a case where a film original sheet is slit into a plurality of films, allows a position on a film original sheet to correspond accurately to a film.

### Brief Description of Drawings

FIG. 1 is a diagram schematically illustrating a cross-sectional configuration of a lithium ion secondary battery in accordance with Embodiment 1.

FIG. 2 provides diagrams schematically illustrating details of the configuration of the lithium ion secondary battery illustrated in FIG. 1.

FIG. 3 provides diagrams schematically illustrating another configuration of the ithium ion secondary battery illustrated in FIG. 1.

FIG. 4 provides diagrams schematically illustrating a defect detecting step and a defect information recording step both Included in a method for marking a defect in a separator original sheet.

FIG. 5 provides diagrams illustrating a configuration of a base material defect inspecting device in the defect detecting step.

FIG. 6 provides diagrams illustrating a configuration of a coating defect inspecting device in the defect detecting step.

FIG. 7 provides diagrams illustrating a configuration of a pinhole defect inspecting device in the defect detecting step.

FIG. 8 is a diagram illustrating an example of where a defect code is formed on a separator original sheet.

FIG. 9 provides diagrams schematically illustrating a configuration of a slitting apparatus configured to slit a separator original sheet.

FIG. 10 provides a side view and an elevational view of a cutting device included in the slitting apparatus illustrated in FIG. 9.

FIG. 11 is a diagram schematically illustrating a reading step, a mark providing step, and a wind-up step all included in a method for specifying the position of a defect in a separator.

FIG. 12 is a diagram schematically illustrating a determining step of determining the width wise dimension or widthwise position of a separator original sheet.

FIG. 13 provides diagrams schematically illustrating a widthwise displacement and widthwise expansion or contraction of a separator original sheet.

FIG. 14 provides diagrams schematically illustrating a mark sensing step and a defect removing step both included in a method for specifying the position of a defect in a separator.

FIG. 15 provides diagrams schematically illustrating a defect detecting step and a defect information recording step both included in a method in accordance with Embodiment 2 for marking a defect in a separator original sheet.

FIG. 16 is a diagram schematically illustrating a reading step, a mark providing step, and a wind-up step all included in a method for specifying the position of a defect in a separator.

### DESCRIPTION OF EMBODIMENTS

The following description will discuss embodiments of the present invention in detail.

### Embodiment 1

The following description will discuss, in order, a lithium ion secondary battery, a battery separator, a beat-resistant separator, a heat-resistant separator producing method, a slitting apparatus, and a cutting device in accordance with Embodiment 1.

<Lithium Ion Secondary Battery>

A nonaqueous electrolyte secondary battery, typically, a lithium-ion secondary battery has a high energy density, and therefore, currently widely used not only as batteries for use in devices such as personal computers, mobile phones, and mobile information terminals, and for use in moving bodies such as automobiles and airplanes, but also as stationary batteries contributing to stable power supply.

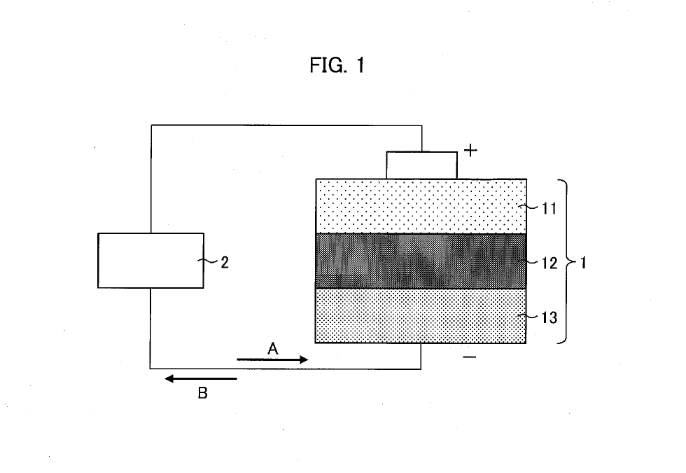

FIG. 1 is a diagram schematically illustrating a cross-sectional configuration of a lithium ion secondary battery 1. As illustrated in FIG. 1, the lithium-ion secondary battery 1 includes a cathode 11, a separator 12, and an anode 13. Between the cathode 11 and the anode 13, an external device 2 is connected outside the lithium-ion secondary battery 1. Then, while the lithium-ion secondary battery 1 is being charged, electrons move in a direction A. On the other hand, while the lithium-ion secondary battery 1 is being discharged, electrons move in a direction B.

<Separator>

The separator 12 is provided so as to be sandwiched between the cathode 11 which is a positive electrode of the lithium-ion secondary battery 1 and the anode 13 which is a negative electrode of the lithium-ion secondary battery 1. The separator 12 is a porous film which separates the cathode 11 and the anode 13, allowing lithium ions to move between the cathode 11 and the anode 13. The separator 12 contains, for example, polyolefin such as polyethylene or polypropylene as a material.

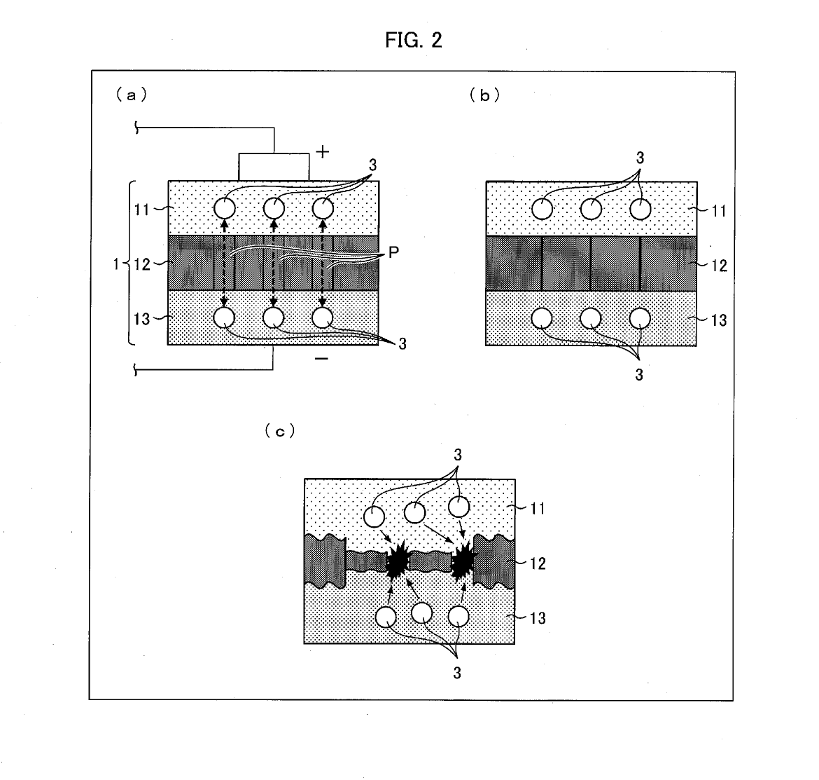

FIG. 2 provides diagrams schematically illustrating details of the configuration of the lithium-ion secondary battery 1 illustrated in FIG. 1. (a) of FIG. 2 illustrates a normal configuration. (b) of FIG. 2 illustrates a state in which a temperature of the lithium-ion secondary battery 1 has risen. (c) of FIG. 2 illustrates a state in which a temperature of the lithium-ion secondary battery 1 has sharply risen.

As illustrated in (a) of FIG. 2, the separator 12 is provided with many pores P. Normally, lithium ions 3 in the lithium-ion secondary battery 1 can move back and forth through the pores P.

However, there are, for example, cases in which the temperature of the lithium-ion secondary battery 1 rises due to excessive charging of the lithium-ion secondary battery 1, a high current caused by short-circuiting of the external device, or the like. In such cases, the separator 12 melts or softens, and the pores P are blocked as illustrated in (b) of FIG. 2. As a result, the separator 12 contracts. This stops the above back-and-forth movement of the lithium ions 3, and consequently stops the above temperature rise.

However, in a case where a temperature of the lithium-ion secondary battery 1 sharply rises, the separator 12 suddenly contracts. In this case, as illustrated in (c) of FIG. 2, the separator 12 may be destroyed. Then, the lithium ions 3 leak out from the separator 12 which has been destroyed. As a result, the lithium ions 3 do not stop moving back and forth. Consequently, the temperature continues rising.

<Heat-Resistant Separator>

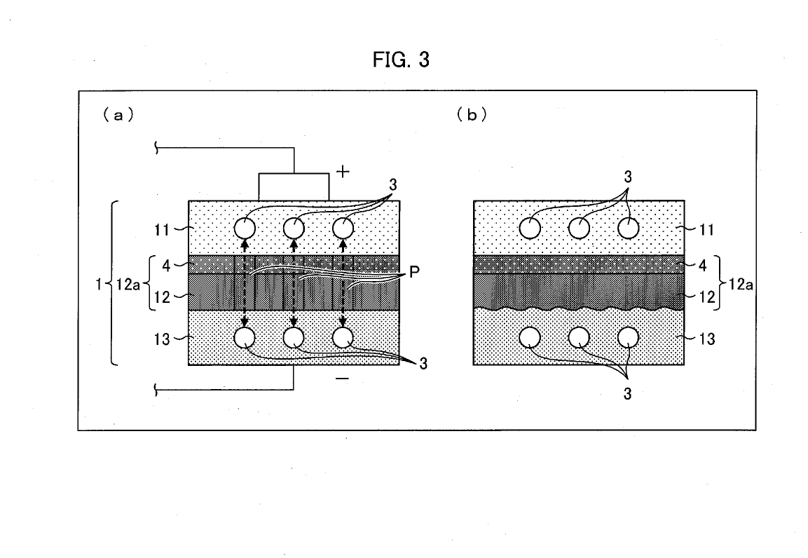

FIG. 3 provides diagrams schematically illustrating another configuration of the lithium-ion secondary battery 1 illustrated in FIG. 1. (a) of FIG. 3 illustrates a normal configuration, and (b) of FIG. 3 illustrates a state in which a temperature of the lithium-ion secondary battery 1 has sharply risen.

As illustrated in (a) of FIG. 3, the lithium-ion secondary battery 1 can further include a heat-resistant layer 4. The heat-resistant layer 4 and the separator 12 form a heat-resistant separator 12a (separator). The heat-resistant layer 4 is laminated on a surface of the separator 12 which surface is on a cathode 11 side. Note that the heat-resistant layer 4 can be alternatively laminated on a surface of the separator 12 which surface is on an anode 13 side, or on both surfaces of the separator 12. Further, the heat-resistant layer 4 is provided with pores which are similar to the pores P. Normally, the lithium ions 3 move back and forth through the pores P and the pores of the heat-resistant layer 4. The heat-resistant layer 4 contains, for example, wholly aromatic polyamide (aramid resin) as a material.

As illustrated in (b) of FIG. 3, even in a ease where the temperature of the hthium-ion secondary battery 1 sharply, rises and accordingly the separator 12 has melted or softened, the shape of the separator 12 Is maintained because the heat-resistant layer 4 supports the separator 12. Therefore, such a sharp temperature rise results in only melting or softening of the separator 12 and consequent blocking of the pores P. This stops back-and-forth movement of the lithium ions 3 and consequently stops the above-described excessive discharging or excessive charging. In this way, the separator 12 can be prevented from being destroyed.

<Steps of Producing Heat-Resistant Separator Original Sheet (Separator Original Sheet)>

How to produce the heat-resistant separator 12a of the lithium-ion secondary battery 1 is not specifically limited. The heat-resistant separator 12a can be produced by a well-known method. The following discussion assumes a case where the separator 12 contains polyethylene as a main material. However, even in a case where the separator 12 contains another material, the similar steps can still be applied to production of the heat-resistant separator 12a.

For example, it is possible to employ a method including the steps of first forming a film by adding an inorganic filler or plasticizer to a thermoplastic resin, and then removing the inorganic filler or plasticizer with an appropriate solvent. For example, in a case where the separator 12 is a polyolefin separator made of a polyethylene resin containing ultrahigh molecular weight polyethylene, it is possible to produce the separator 12 by the following method.

This method includes (1) a kneading step of obtaining a polyethylene resin composition by kneading an ultrahigh molecular weight polyethylene with an inorganic filler (for example, calcium carbonate or silica) or plasticizer (for example, a low-molecular weight polyolefin or liquid paraffin), (2) a rolling step of forming a film with the polyethylene resin composition, (3) a removal step of removing the inorganic filler or plasticizer from the film obtained in the step (2), and (4) a stretching step of obtaining the separator 12 by stretching the film obtained in the step (3). The step (4) can alternatively be carried out between the steps (2) and (3).

In the removal step, many fine pores are provided in the film. The fine pores of the film stretched in the stretching step become the above-described pores P. The separator 12 formed as a result is a polyethylene microporous film having a prescribed thickness and a prescribed air permeability.

Note that, in the kneading step, 100 parts by weight of the ultrahigh molecular weight polyethylene, 5 parts by weight to 200 parts by weight of a low-molecular weight polyolefin having a weight-average molecular weight of 10000 or less, and 100 parts by weight to 400 parts by weight of the inorganic filler can be kneaded.

Thereafter, in a coating step, the heat-resistant layer 4 is formed on a surface of the separator 12. For example, on the separator 12, an aramid/NMP (N-methylpyrrolidone) solution (coating solution) is applied, and thereby, the heat-resistant layer 4 that is an aramid heat-resistant layer is formed. The heat-resistant layer 4 can foe provided on only one surface or both surfaces of the separator 12. Alternatively, the heat-resistant layer 4 can be formed by using, for coating, a mixed solution containing a filler such as alumina/carboxy methyl cellulose.

Further, in the coating step, a polyvinylidene fluoride/dimethylacetamide solution (coating solution) can he applied (applying step) to a surface of the separator 12 and solidified (solidifying step) so that an adhesive layer is formed on the surface of the separator 12. The adhesive layer can be provided on only one surface or both surfaces of the separator 12.

A method for coating the separator 12 with a coating solution is not specifically limited as long as uniform wet coating can be performed by the method. The method can be a conventionally well-known method such as a capillary coating method, a spin coating method, a slit die coating method, a spray coating method, a dip coating method, a roll coating method, a screen printing method, a flexo printing method, a bar coaler method, a gravure coater method, or a die coater method. The heat-resistant layer 4 has a thickness which can be controlled by adjusting a thickness of a coating wet film, a solid-content concentration which is the sum of concentrations of a binder and a filler in the coating solution, and a ratio of the filler to the binder.

It is possible to use a resin film, a metal belt, a drum or the like as a support with which the separator 12 is fixed or conveyed in coating.

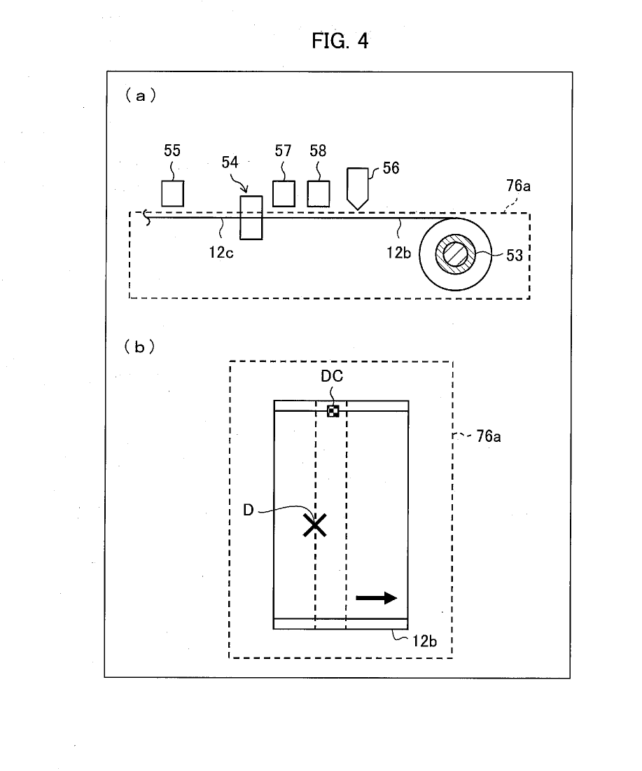

It is thus possible to produce a heat-resistant separator original sheet 12b which is a separator original sheet 12c on which the heat-resistant layer 4 is laminated (FIG. 4). The heat-resistant separator original sheet 12b thus produced is wound around a core 53 having a cylindrical shape (FIG. 4). Note that a subject to foe produced by the above production method is not limited to the heat-resistant separator original sheet 12b. The above production method does not necessarily include the coating step. In a case where the method includes no coating step, the subject to be produced is a separator original sheet 12c. The description below mainly deals with an example of a heat-resistant separator (film) including a heat-resistant layer as a functional layer. A similar process (steps) can be carried out also for a separator (film) and separator original sheet (film original sheet) each including no functional layer.

<Defect Detecting Step>

In a case where during production of a heat-resistant separator for use in a lithium ion secondary battery, an inspecting device has detected a defect m a coating step of preparing a heat-resistant separator original sheet including a separator original sheet coated with a heat-resistant layer, the original sheet having the defect is provided with a line drawn with a marker before the heat-resistant separator original sheet is wound up. In the subsequent slitting step, the heat-resistant separator original sheet is wound off. Then, when an operator sees the line drawn with the marker on the heat-resistant separator original sheet wound off, the operator stops the operation of winding off the heat-resistant separator original sheet. Next, the operator visually checks the position, along the width of the heat-resistant separator original sheet, of the defect indicated by the line drawn with the marker. Next, that portion of the heat-resistant separator original sheet on which the line is drawn with the marker is slit by a cutting device lengthwise to form a plurality of heat-resistant separators. Then, the operator attaches, to one of the heat-resistant separators, a piece of tape in such a manner that the tape extends beyond a side of the heat-resistant separator and that the tape coincides with the lengthwise position of the heat-resistant separator at which the defect indicated by the line drawn with the marker is present. The heat-resistant separator, to which the tape is attached in such a manner that the tape extends beyond a side of the heat-resistant separator, is wound up around a wind-up roller.

Next, the heat-resistant separator wound up around the wind-up roller is wound off from the wind-up roller and then wound up around an additional wind-up roller in an additional wind-up step. When an operator sees the tape in the additional wind-up step, the operator stops the operation of the additional wind-up step. The operator then cuts off. in the widthwise direction, that portion of the heat-resistant separator at which the defect indicated by the tape is present, and removes that portion from the rest. Next, the heat-resistant separator on the side of the wind-up roller is connected with the heat-resistant separator on the side of the additional wind-tip roller. Then, the operation of the additional wind-up step is resumed, so that the heat-resistant separator is all wound off from the wind-up roller and then wound up around the additional wind-up roller.

This procedure is, however, problematic in that it merely involves drawing a line on a heat-resistant separator original sheet with a marker in a case where an inspecting device has detected a defect in the heat-resistant separator original sheet. Thus, when an operator sees the line in the subsequent slitting step, the operator needs to stop the operation of winding-off the heat-resistant separator original sheet and visually check the widthwise position of the defect. Enormous efforts are thus needed in order to specify the position of the defect in a plurality of heat-resistant separators prepared by slitting the heat-resistant separator original sheet.

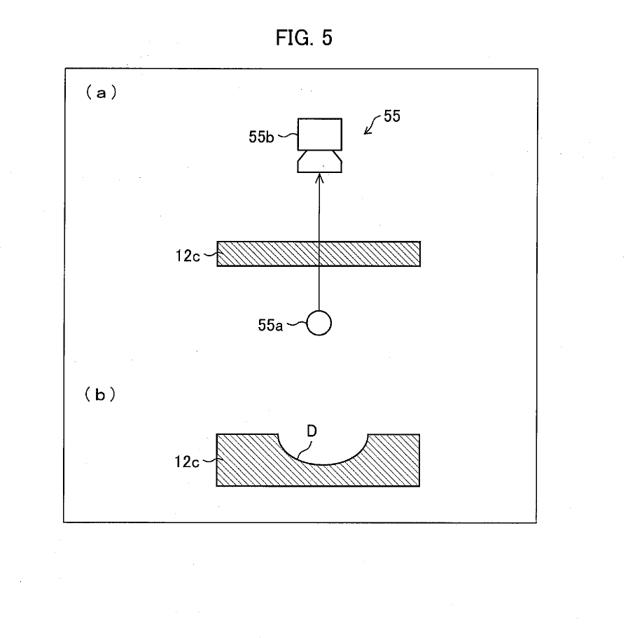

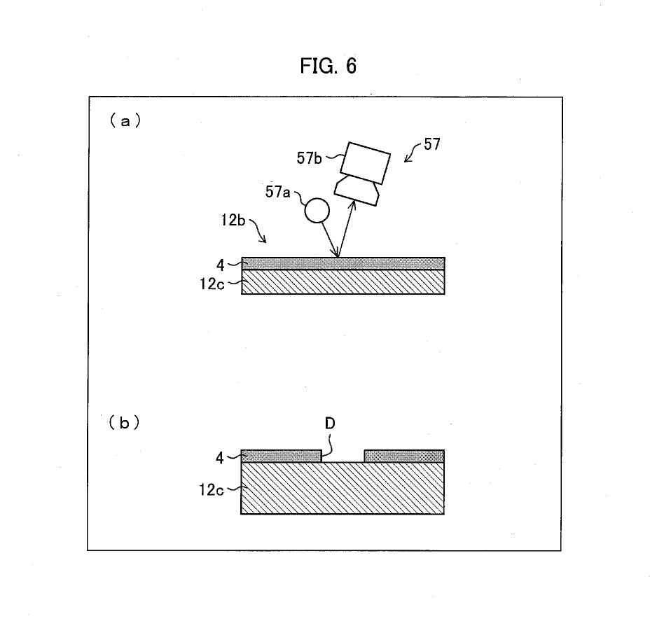

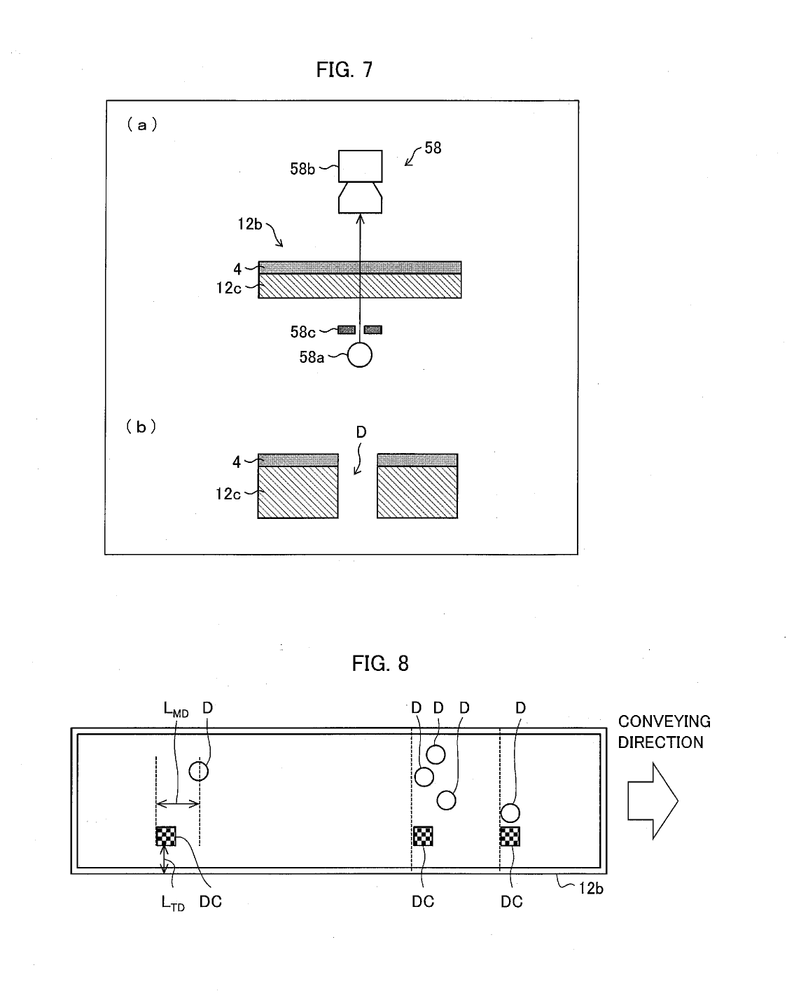

FIG. 4 provides diagrams schematically illustrating a defect detecting step and a defect information recording step both included in a method for marking a defect in the heat-resistant separator original sheet 12b. (a) of FIG. 4 is an elevational view of a conveying mechanism 76a during the two steps, whereas (b) of FIG. 4 is a plan view of the conveying mechanism 76a during the two steps. FIG. 5 provides diagrams illustrating a configuration of a base material defect inspecting device 55 in the defect detecting step. FIG. 6 provides diagrams illustrating a configuration of a coating defect inspecting device 57 in the defect detecting step. FIG. 7 provides diagrams illustrating a configuration of a pinhole defect inspecting device 58 in the defect detecting step.

As illustrated in (a) of FIG. 4, a heat-resistant layer is formed on a separator original sheet 12c by the coating section 54 so that a heat-resistant separator original sheet 12b is prepared. The heat-resistant separator original sheet 12b is conveyed by a conveying mechanism 76a (first conveying mechanism) and wound up around a core 53. Specifically, the production process includes a base material inspecting step (defect detecting step), which is a step of inspecting the separator original sheet 12c for a defect D. The base material inspecting step is carried out by a base material defect inspecting device 55 (defect detecting section, separator producing apparatus) between a step of unreeling the separator original sheet 12c and the coating step. The base material defect inspecting device 55 includes a light source 55a and a detector 55b that are so positioned that the separator original sheet 12c is conveyed through a space between the light source 55a and the detector 55b. The light source 55a emits light in a direction perpendicular to the front and back surfaces of the separator original sheet 12c, whereas the detector 55b detects light having passed through the separator original sheet 12c. This allows the base material defect inspecting device 55 to inspect the separator original sheet 12c for a defect D present wherein, that is, specify the position of a defect D (defect detecting step). The defect D present in the separator original sheet 12c is, for example, a through hole (pinhole), an inappropriate film thickness, or a defect caused by a foreign substance.

The production process further includes a coating inspecting step (defect detecting step) of inspecting the heat-resistant layer 4, formed on the separator original sheet 12c being conveyed, for a defect D. The coating inspecting step is carried out by a coating defect, inspecting device 57 (defect detecting section, separator producing apparatus) between the coating step and a step of winding up the heat-resistant separator original sheet 12b around the core 53. The coating defect inspecting device 57 includes a light source 57a and a detector 57b that are positioned on the side of the heat-resistant layer 4 of the heat-resistant separator original sheet 12b. The light source 57a emits light to the heat-resistant layer 4, whereas the detector 57b detects light having been reflected by the heat-resistant layer 4. This allows the coating defect inspecting device 57 to detect a defect D present in the heat-resistant layer 4 (that is, specify the position of a defect D). The defect D present in the heat-resistant layer 4 is, for example, a crease, peeling off, repellency, and a surface failure. The repellency refers to a defect of a foreign substance, oil, or the like on the surface of the separator original sheet 12c repelling the coating solution from the surface, with the result of local absence of a heat-resistant layer 4 or local formation, of an extremely thin heat-resistant layer 4. The surface failure refers to a failure in the thickness of the heat-resistant layer 4.

The production process further includes a pinhole inspecting step (defect, detecting step) of inspecting the heat-resistant separator original sheet 12b during the conveyance for a defect D in the form of a pinhole. The pinhole inspecting step is carried out by a pinhole defect inspecting device 58 (defect detecting section, separator producing apparatus) positioned between the coating defect inspecting device 57 and a defect information recording device 56. The pinhole defect inspecting device 58 includes a light source 58a, a. detector 58b, and a slit 58c. The light source 58a is positioned on the side of the separator original sheet 12c of the heat-resistant separator original sheet 12b, and emits light in a direction perpendicular to the front and back surfaces of the heat-resistant separator original sheet 12b. The slit 58c lets the light pass therethrough and travel toward the heat-resistant separator original sheet 12b. The detector 58b detects a defect D (that is, specifies the position of a defect D) on the basis of light having passed through the heat-resistant separator original sheet 12b. The defect D in the form of a pinhole has a diameter ranging from several hundreds of micrometers to several millimeters.

The production process involves a defect information recording device 56 positioned between the pinhole defect inspecting device 58 and the core 53. The defect, information recording device 56 records, on the heat-resistant separator original sheet 12b, a defect code DC indicative of information on the position of any defect D detected by the base material defect inspecting device 55, the coating defect inspecting device 57, or the pinhole defect inspecting device 58. The defect information recording device 56 records such a defect code DC at a portion on a width wise side of the heat-resistant separator original sheet 12b which portion corresponds to a lengthwise position of the defect D on the heat-resistant separator original sheet 12b. The defect code DC may be code data such as a two-dimensional code or QR Code (registered trademark). The information on the position indicates where the defect D is positioned in the lengthwise and widthwise directions of the heat-resistant separator original sheet 12b. The information on the position may include information with, which the type of the defect D is distinguishable. The type of a defect D is, for example, (i) a structural defect in the base material for which defect the base material defect inspecting device 55 inspects the separator original sheet 12c, (ii) a defect caused in the applying step for which defect the coating defect inspecting device 57 inspects the heat-resistant layer 4, or (iii) a defect in the form of an opening for which defect the pinhole defect inspecting device 58 inspects the heat-resistant separator original sheet 12b.

The separator original sheet 12c or heat-resistant separator original sheet 12b is subjected to a film tension of typically riot more than 200 N/m, preferably not more than 120 N/m. The term “film tension” refers to a tension applied to a film being conveyed, the tension being applied in the conveying direction over a unit widthwise length of the film. For instance, with a film tension of 200 N/m, a force of 200 N is applied to the film over a width of 1 m. A film tension of more than 200 N/m may form a wrinkle in the conveying direction of the film and decrease the accuracy of defect inspection. The film tension is typically not less than 10 N/m, preferably not less than 30 N/m. A film tension of less than 10 N/m may cause slack in the film or let the film meander. The separator original sheet 12c or heat-resistant separator original sheet 12b has pores P, and is subjected to a film tension lower than a film tension applied to a non-porous film such as an optical film. The separator original sheet 12cor heat-resistant separator original sheet 12b thus has a physical property of being stretch-able more easily than a non-porous film such as an optical film. As such, in a case where a defect code DC is recorded at a portion on a widthwise side of the heat-resistant separator original sheet 12b which portion corresponds to a lengthwise position of the defect D on the heat-resistant separator original sheet 12b, the lengthwise position of the defect D is substantially not displaced from the lengthwise position of the defect code DC even in a case where the heat-resistant separator original sheet 12b has been stretched lengthwise. The lengthwise position of a defect D is thus easily specifiable even in the case where the heat-resistant separator original sheet 12b has been stretched lengthwise.

The heat-resistant separator original sheet 12b with a defect code DC recorded at a portion on a widthwise side thereof is wound up around the core 53. The core 53, around which the heat-resistant separator original sheet. 12b has been wound up, is carried to a position for the subsequent, slitting step. The separator original sheet 12b is conveyed by the conveying mechanism 76a and a conveying section 76b, which are independent of each other and which include respective wind-up rollers that apply respective tensions different from each other to the separator original sheet 12b for the conveyance. The separator original sheet 12b, having been subjected to the defect defecting step, is temporarily wound up by the conveying mechanism 76a. The separator original sheet 12b, which has been wound up, is wound off again by the conveying section 76b to be subjected to the slitting step.

FIG. 8 is a diagram illustrating an example of where a defect code DC is formed on a separator original sheet 12b. The defect information recording device 56 (see FIG. 4) records a defect code DC indicative of information on the positional of a defect D at a portion on a widthwise side of the heat-resistant separator original sheet 12b which portion corresponds to a lengthwise position of the defect D on the heat-resistant separator original sheet 12b. A defect D is separated from its corresponding defect code DC by a lengthwise distance L_{MD} of, for example, preferably not more than 100 mm, more preferably not more than 30 mm. The defect code DC is separated from a widthwise side of the heat-resistant separator original sheet 12b by a distance L_{TD} of, for example, preferably not more than 50 mm, more preferably not more than 20 mm. The distance LTD is preferably not less than 3 mm because the widthwise sides of the heat-resistant separator original sheet 12b easily become wavy.

<Slitting apparatus>

The heat-resistant separator 12a (hereinafter referred to as “separator”), produced from the heat-resistant separator original sheet 12b (hereinafter referred to as “separator original sheet”), or the separator 12, produced from the separator original sheet 12c, has a width (hereinafter referred to as “product width”) suitable for application products such as the lithium-ion secondary battery 1. However, for improving productivity, the separator original sheet is produced so as to have a width that is equal to or larger than a product width. Then, after having been once produced so as to have a width equal to or larger than the product width, the separator original sheet is slit into a separator(s) having the product width.

Note that the “separator width” means a dimension of the separator in a direction parallel to the plane on which the separator extends and perpendicular to the lengthwise direction of the separator. Moreover, “slit” means to cut off a separator original sheet lengthwise (i.e., in a direction in which a film flows in production, MD: machine direction), whereas “cut” means to cut the separator original sheet or separator in a transverse direction (TD). The transverse direction (TD) means a direction (widthwise direction) that is substantially perpendicular to the lengthwise direction (MD) and the thickness direction of the separator.

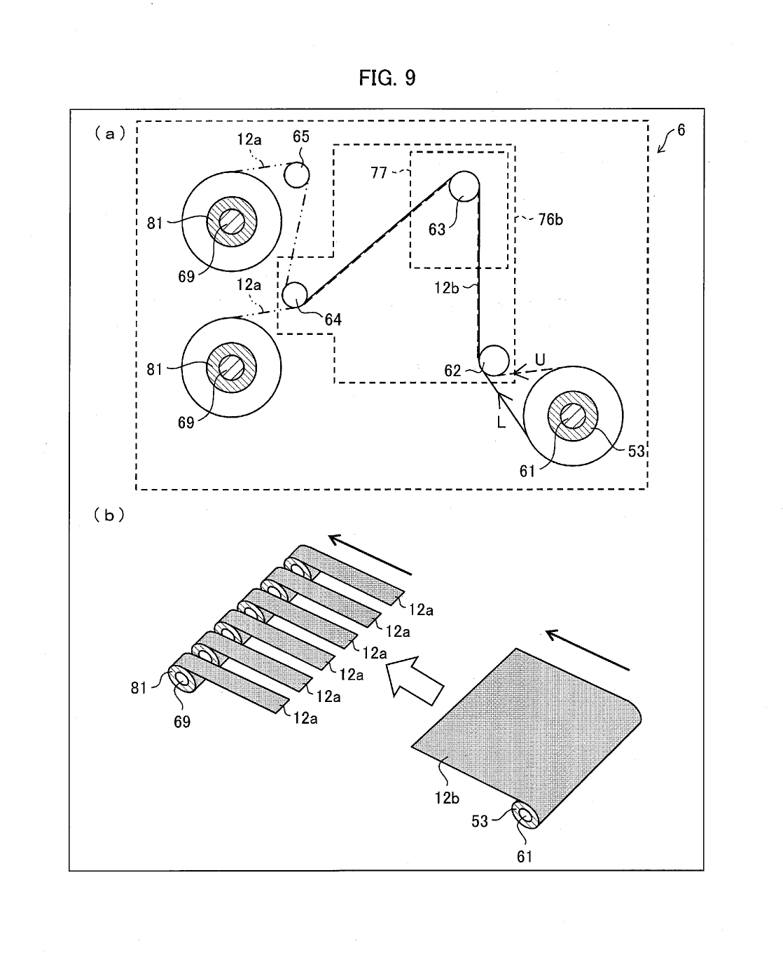

FIG. 9 provides diagrams schematically illustrating a configuration of a slitting apparatus 6 configured to slit the separator original sheet 12b. (a) of FIG. 9 illustrates an entire configuration, and (b) of FIG. 9 illustrates an arrangement before and after slitting the separator original sheet 12b.

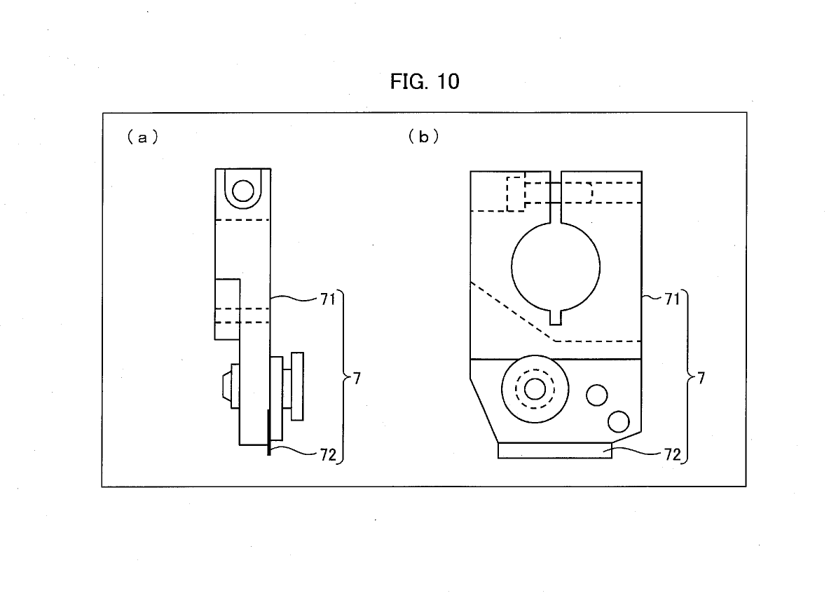

As illustrated in (a) of FIG. 9, the slitting apparatus 6 includes a rotatably supported cylindrical wind-off roller 61, rollers 62 to 65, and wind-up rollers 69. The slitting apparatus 6 is further provided with a cutting device 7 (FIG. 10) described later. The rollers 62 to 64 constitute a conveying section 76b (second conveying mechanism) for conveying the separator original sheet 12b or heat-resistant separators 12a.

<Before Slitting>

In the slitting apparatus 6, a cylindrical core 53 on which the separator original sheet 12b is wrapped is fit on the wind-off roller 61. As illustrated in (a) of FIG. 9, the separator original sheet 12b is wound off from the core 53 to a route U or L. The separator original sheet 12b thus wound off is conveyed to the roller 64 via the roller 63 at a speed of, for example, 100 m/min. In the conveying step, the separator original sheet 12b is slit lengthwise into a plurality of heat-resistant separators 12a.

<After Slitting>

as illustrated in (a) of FIG. 9. one or more of the plurality of heat-resistant separators 12a are wound up around respective cores 81 (bobbins) fit on the plurality of wind-up rollers 69. Further, another one or more of the plurality of heat-resistant separators 12a are wound up around respective cores 81 (bobbins) fit on the plurality of wind-up rollers 69. Note that each of the slit separators wound into a roll form is referred to as a “separator roll”.

<Cutting Device>

FIG. 10 provides diagrams each illustrating a configuration of the cutting device 7 (cutting section) of the slitting apparatus 6 as illustrated in (a) of FIG. 9. (a) of FIG. 10 is a side view of the cutting device 7, and (b) of FIG. 10 is a front view of the cutting device 7.

As illustrated in (a) and (b) of FIG. 10, the cutting device 7 includes a holder 71 and a blade 72. The holder 71 is fixed to a housing or the like provided in the slitting apparatus 6. The holder 71 holds the blade 72 in such a manner that the blade 72 and the separator original sheet 12b being conveyed have a fixed positional relation. The blade 72 has a finely sharpened edge and slits the separator original sheet by using this edge.

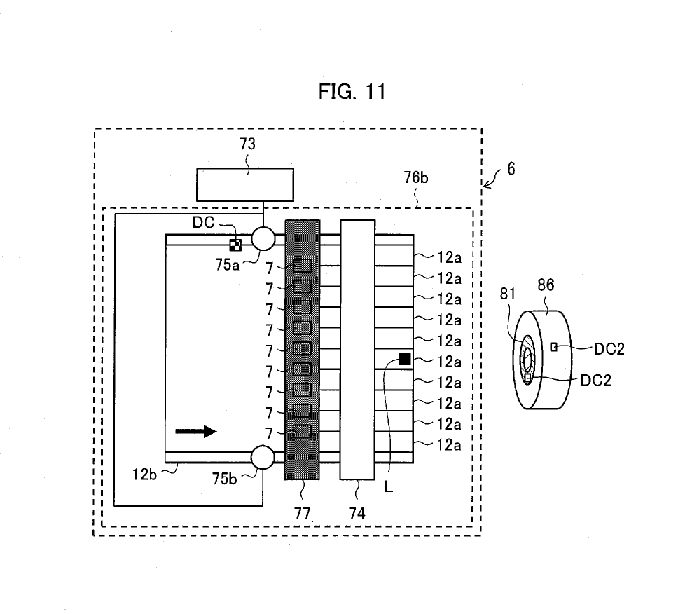

FIG. 11 is a diagram schematically illustrating a determining step, a reading step, a cutting step, an identifying step, a mark providing step, and a wind-up step all included in a method for specifying the position of a defect in the heat-resistant separator 12a. The separator original sheet 12b is wound off from the core 53 (FIG. 9) at a fixed speed (for example, 80 m/min).

As illustrated in FIG. 11, the slitting apparatus 6, which is included in a separator producing apparatus (film producing apparatus), includes a slitting section 77, a conveying section 76b, a reading section 73, and a mark providing device 74. The slitting section 77 includes a plurality of cutting devices 7, each of which includes a blade 72 at a cutter position. In the slitting step, the slitting section 77 slits the separator original sheet 12b, conveyed lengthwise, along slit lines extending in the conveying direction (MD) past the respective cutter positions, and thus prepares a plurality of heat-resistant separators 12a.

<Determining Widthwise Dimension or Widthwise Position of Separator Original Sheet>

The reading section 73 includes detection cameras 75a and 75b (determining section, defect code reading section) that are so positioned as to photograph the opposite widthwise ends of the separator original sheet 12b. The detection cameras 75a and 75b optically determine the widthwise dimension or widthwise position of the separator original sheet 12b being conveyed in the slitting apparatus 6 (determining step). The determination and slitting for the separator original sheet 12b are performed on the heat-resistant separator 12a being conveyed by the same conveying section 76b.

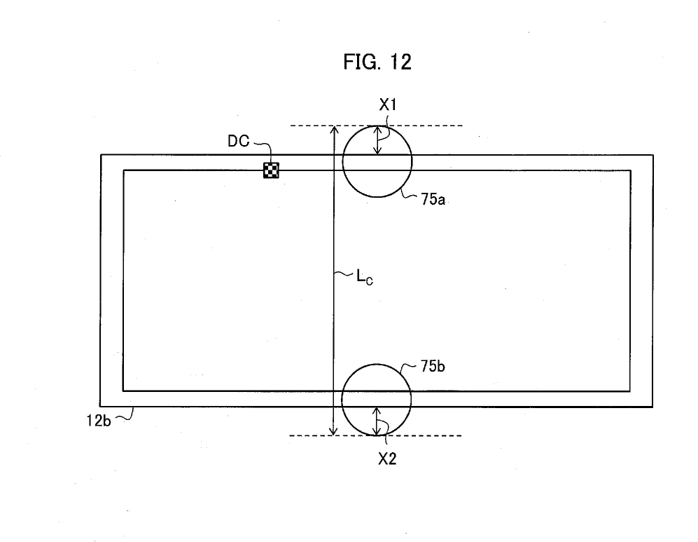

FIG. 12 is a diagram schematically illustrating the determining step, which is a step of determining the widthwise dimension or widthwise position of the separator original sheet 12b. In the determining step, the detection cameras 75a and 75b measure a widthwise displacement of the separator original sheet 12b or widthwise expansion or contraction of the separator original sheet 12b.

The widthwise displacement of the separator original sheet 12b refers to (i) how much the separator original sheet 12b being conveyed by the conveying section 76b has been displaced widthwise from the intended position of the separator original sheet 12b or (ii) how much the separator original sheet 12b has been displaced widthwise from the widthwise position of the separator original sheet 12b being conveyed in the defect detecting step described earlier with reference to FIG. 4.

The widthwise expansion or contraction of the separator original sheet 12b refers to (i) how much the separator original sheet 12b being conveyed by the conveying section 76b has expanded or contracted widthwise with respect to the intended dimension of the separator original sheet 12b or (ii) how much the separator original sheet 12b has expanded or contracted widthwise with respect to the widthwise dimension of the separator original sheet 12b being conveyed in the defect detecting step described earlier with reference to FIG. 4.

Specifically, first, the detection camera 75a measures the distance X1 between (i) a widthwise end of the separator original sheet 12b being conveyed by the conveying section 76b and (ii) a reference position for the detection camera 75a (for example, an outer end of the photographing range). The detection camera 75b measures the distance X2 between (i) the other widthwise end of the separator original sheet 12b and (ii) a reference position for the detection camera 75b (for example, an outer end of the photographing range).

Next, the reading section 73 (determining section, identifying section) calculates the widthwise dimension Lc of the separator original sheet 12b on the basis of (i) the distance X1, measured by the detection camera 75a, and (ii) the distance X2, measured by the detection camera 75b. The reading section 73 calculates expansion or contraction of the widthwise dimension of the separator original sheet 12b, being conveyed by the conveying section 76b, with respect to the same dimension in the defect detecting step. The reading section 73 further calculates the widthwise position of the separator original sheet 12b on the basis of the distance X1 and the distance X2. Then, the reading section 73 calculates displacement of the widthwise position of the separator original sheet 12b, being conveyed by the conveying section 76b, from the intended position.

The separator producing method of Embodiment 1, as described above, includes a slitting step involving determining the widthwise dimension and widthwise position of a separator original sheet 12b being conveyed by the conveying section 76b. This makes it possible to slit a separator original sheet in view of a variation of the widthwise dimension or widthwise position of the separator original sheet 12b. For instance, as the slitting step makes it possible to obtain accurate information on the widthwise dimension or widthwise position of a separator original sheet 12b being conveyed, the separator producing method allows the position of the separator original sheet 12b to correspond accurately to one of a plurality of separators prepared by slitting a separator original sheet.

<Identifying Separator with Defect Present Therein>

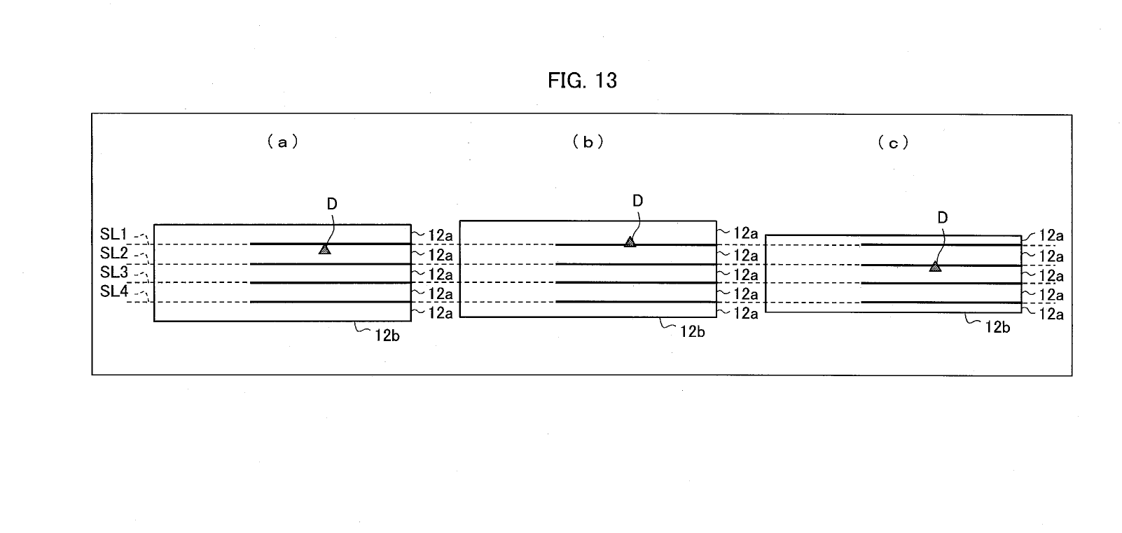

FIG. 13 provides diagrams schematically illustrating a widthwise displacement and widthwise expansion or contraction of a separator original sheet 12b. (a) of FIG. 13 illustrates a widthwise position of a separator original sheet 12b which widthwise position is the intended position of a separator original sheet 12b on the conveying section 76b. The intended position refers to a position at which a separator original sheet 12b is designed to be positioned, (b) of FIG. 13 illustrates a widthwise position of a separator original sheet 12b which widthwise position is an example position of a separator original sheet 12b being conveyed by the conveying section 76b in the determining step illustrated in FIGS. 11 and 12.

As illustrated in (a) and (b) of FIG. 13, in a case where the widthwise position of a separator original sheet 12b in the determining step has been displaced from the intended position by meandering and/or deformation of the separator original sheet 12b being conveyed, the slit lines SL1, SL2, SL3, and SL4 for the separator original sheet 12b are also displaced widthwise with respect to the separator original sheet 12b, with the possible result that the defect D is present in a different heat-resistant separator 12a. For instance, in a case where the position of a separator original sheet 12b is not displaced widthwise, the separator original sheet 12b will be slit such that the defect D will be present in the second heat-resistant separator 12a from the top as illustrated in (a) of FIG. 13. On the other hand, in a case where the position of a separator original sheet 12b is displaced widthwise as illustrated in (b) of FIG. 13, the separator original sheet 12b will be slit such that the defect D will be present in the first heat-resistant separator 12a.

To prevent such a problem, the reading section 73 identifies, on the basis of (i) the widthwise position of the defect D present in the separator original sheet 12b which widthwise position was detected in the defect detecting step and (ii) the widthwise position of the separator original sheet 12b which widthwise position was determined in the determining step, which of the plurality of heat-resistant separators 12a prepared by slitting the separator original sheet 12b has the defect D present therein (identifying step).

The separator original sheet 12b, in the determining step, expands or contracts widthwise due to the difference between the strength of tension that acts upon the separator original sheet 12b in the defect detecting step illustrated in FIG. 4 and (ii) the strength of tension that acts upon the separator original sheet 12b in the determining step illustrated in FIGS. 11 and 12.

For instance, in a case where the conveying section 76b applies tension to the separator original sheet 12b in the determining step which tension is larger than the tension that the conveying mechanism 76a applies to the separator original sheet 12b in the defect detecting step, the separator original sheet 12b contracts widthwise in the determining step as illustrated in (c) of FIG. 13. On the other hand, in a case where the conveying section 76b applies tension smaller than the tension that the conveying mechanism 76a applies, the separator original sheet 12b expands widthwise in the determining step.

As described above, in the case where the separator original sheet 12b has expanded or contracted widthwise, the respective positions of the slit lines SL1, SL2, SL3, and SL4 for the separator original sheet 12b with respect to the separator original sheet 12b are changed from the intended positions. This means that the defect D may be present in a different heat-resistant separator 12a.

To prevent such a problem, the reading section 73 identifies, on the basis of (i) the widthwise position of the defect D present in the separator original sheet 12b which widthwise position was detected in the defect detecting step and (ii) the widthwise dimension of the separator original sheet 12b which widthwise position was determined in the determining step, which of the plurality of heat-resistant separators 12a prepared by slitting the separator original sheet 12b has the defect D present therein (identifying step).

The detection camera 75a, included in the reading section 73, detects the position of a widthwise end of the separator original sheet 12b and also reads a defect code DC recorded at the widthwise end of the separator original sheet 12b (defect code reading step). The plurality of cutting devices 7, included in the slitting apparatus 6, slit the separator original sheet 12b lengthwise to prepare a plurality of heat-resistant separators 12a (slitting step).

The example described earlier uses a common detection camera 75a for both the reading step, which is a step of reading a defect code DC, and the step of detecting the position of a widthwise end of the separator original sheet 12b. The present invention is, however, not limited to such a configuration, and may be configured to carry out, independently of each other, the reading step, which is a step of reading a defect code DC, and the step of detecting the position of a widthwise end of the separator original sheet 12b. The present invention may be configured, for example, such that the detection cameras 75a and 75b detect the position of a widthwise end and that another detection camera reads a defect code DC.

In the case where the detection camera 75a both determines the widthwise dimension and widthwise position of a separator original sheet 12b in the determining step and reads a defect code in the reading step as described above, the production process involves simplified equipment.

The separator producing method of Embodiment 1 can accurately identify a heat-resistant separator 12a having a defect present therein, even in the case where the respective positions of slit lines for the separator original sheet 12b have been displaced from the preset positions as a result of (i) the difference between the tension applied to the separator original sheet 12b conveyed in the slitting step and the tension applied in the defect detecting step or (ii) the difference, caused by meandering and/or deformation of the separator original sheet 12b conveyed in the slitting step, between the position of the separator original sheet 12b with respect to the cutting devices 7 and its intended position.

As illustrated in (a) and (b) of FIG. 13, the closer the defect detected in the separator original sheet 12b is to any intended slitting position of the separator original sheet 12b, the higher the risk of a wrong heat-resistant separator 12a being erroneously identified as the heat-resistant separator 12a having the defect present therein. The identifying step should thus preferably make it possible to identify which of a plurality of heat-resistant separators 12a has a defect present therein in further view of the slitting positions for the separator original sheet 12b.

<Defect Removing Step>

Next, the mark providing device 74 provides a mark L at a position corresponding to the defect D in the heat-resistant separator 12a identified as above (mark providing step). In a case where there are a plurality of defects D present, the reading section 73 identifies a plurality of heat-resistant separators 12a. The mark L is preferably a label, so the mark providing device 74 is preferably a labeler.

The mark L may be, instead of a label, a mark drawn with a pen or a mark applied by an injector. The mark L may also be a thermolabel, which is printed by heating the heat-resistant separator 12a (made of resin). The mark L may also be provided by forming a hole in the heat-resistant separator 12a with use of a laser.

The plurality of heat-resistant separators 12a, prepared by slitting the separator original sheet 12b with use of the cutting devices 7, are each wound up around one of a plurality of cores 81 (wind-up step).

The mark providing device 74 then records information on the lengthwise position of the defect D in the separator original sheet 12b, which defect D is indicated by a defect code DC. The mark providing device 74 records such information as a defect code DC2 on (i) an outermost portion 86 of the heat-resistant separator 12a identified and wound up and/or (ii) the core 81.

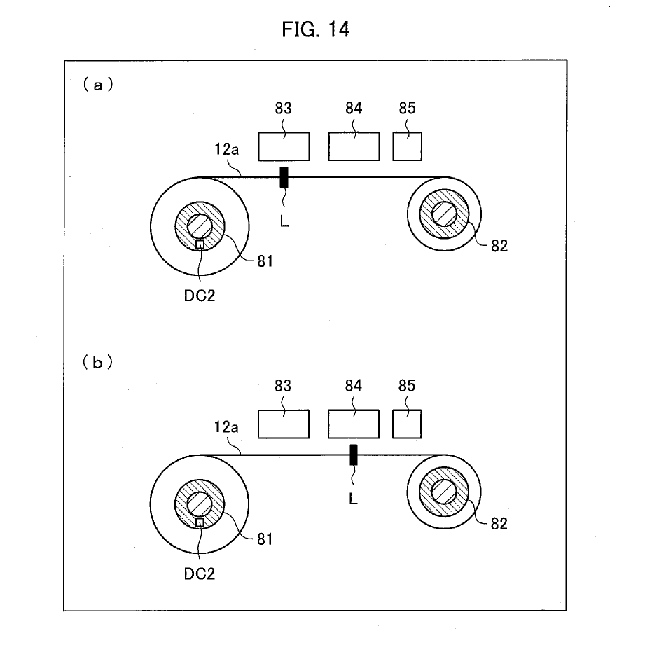

FIG. 14 provides diagrams schematically illustrating a mark sensing step and a defect removing step both included in a method for specifying the position of a defect in the heat-resistant separator 12a. (a) of FIG. 14 is a diagram schematically Illustrating the mark sensing step. (b) of FIG. 14 is a diagram schematically illustrating the defect removing step. The method involves use of a mark sensing device 83, a defect removing device 84, and a connecting device 85. First, the mark sensing device 83 reads the defect code DC2, recorded on the outermost portion 86 and/or core 81. The mark providing device 74 receives information read by the mark sensing device 83 and attaches a mark L to the heat-resistant separator 12a with the defect D present therein. The mark sensing step then starts an operation of winding off the heat-resistant separator 12a from the core 81 and winding up the heat-resistant separator 12a again around a core 82. Next, the mark sensing device 83, on the basis of information on the lengthwise position of the defect D (indicated by the defect code DC2 read by the mark sensing device 83) in the separator original sheet 12b, slows the above operation when the defect D has become close to the core 82.

The mark sensing device 83 then senses the mark L, which is attached to the position corresponding to the defect D in the heat-resistant separator 12a (mark sensing step). When the mark sensing device 83 has sensed the mark L, the mark sensing device 83 stops the operation of winding up the heat-resistant separator 12a again. The defect removing device 84 then cuts the heat-resistant separator 12a widthwise at (i) a position upstream of the defect D, which corresponds to the mark L, and (ii) a position downstream of the defect D and removes the defect D from the heat-resistant separator 12a (defect removing step). The defect removing step may alternatively be carried out manually by an operator instead of the defect removing device 84. The connecting device 85 then connects two portions of the heat-resistant separator 12a that are separated from each other as the result of cutting the heat-resistant separator 12a (connecting step). The connecting step may alternatively be carried out manually by an operator instead of the connecting device 85. Next, the connecting device 85 resumes the operation of winding up the heat-resistant separator 12a again. The operation of winding off the heat-resistant separator 12a from the core 81 and winding up the heat-resistant separator 12a again around the core 82 is then completed. The two portions of the heat-resistant separator 12a, which result from dividing the heat-resistant separator 12a, may alternatively be left unconnected to be individually wound up around separate cores. In other words, the heat-resistant separator 12a may be wound up again in such a manner that that portion of the heat-resistant separator 12a which is downstream of the removed portion is wound up around the core 82, whereas that portion of the heat-resistant separator 12a which is upstream of the removed portion is wound up around another core.

### Embodiment 2

Embodiment 1 is an example in which information on the position of a defect D present in a separator original sheet 12b is recorded at a widthwise end of the separator original sheet 12b. The present invention is, however, not limited to such a configuration, and may be configured such that information on the position of a defect D is recorded in an information storing device.

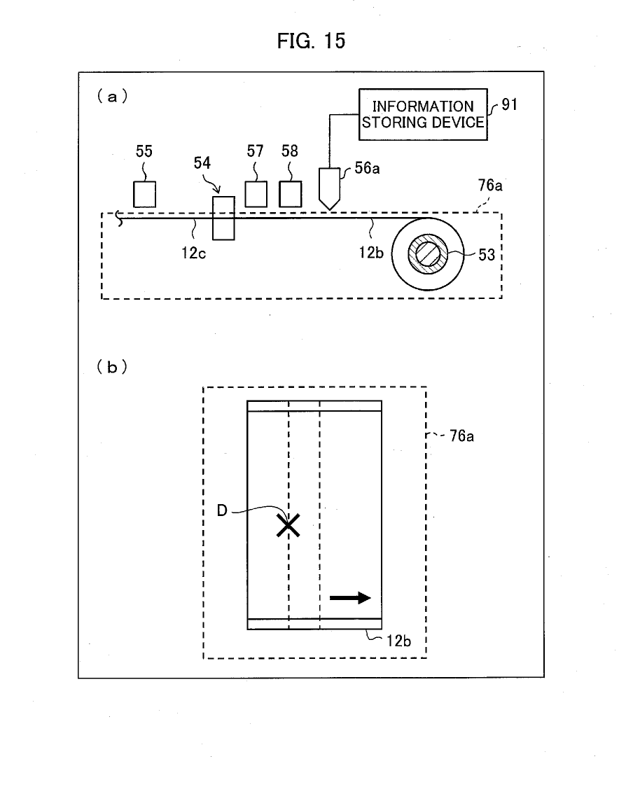

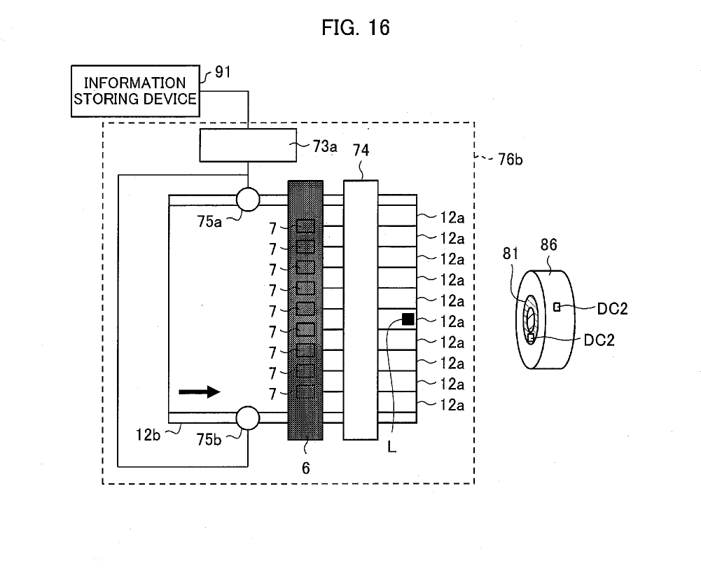

FIG. 15 provides diagrams schematically illustrating a defect detecting step and a defect information recording step both included in a method in accordance with Embodiment 2 for marking a defect in a separator original sheet 12b. FIG. 16 is a diagram schematically illustrating a determining step, a reading step, a slitting step, an identifying step, a mark attaching step, and a wind-up step all included in a method for specifying the position of a defect in a heat-resistant separator 12a. Any constituent element of Embodiment 2 that is identical to a corresponding constituent element described earlier for Embodiment 1 is assigned a common reference sign, and is not described in detail here.

Unlike Embodiment 1, Embodiment 2 includes a defect information recording device 56a, an information storing device 91, and a reading section 73a. The defect information recording device 56a records, in the information storing device 91, positional information indicative of the lengthwise and widthwise positions of a defect D that is present in the separator original sheet 12c or 12b and that has been detected by the base material defect inspecting device 55, the coating defect inspecting device 57, or the pinhole defect inspecting device 58. The reading section 73a reads the positional information from the information storing device 91.

### Embodiment 3

Embodiment 1 is a separator producing method or separator producing apparatus configured such that the detection cameras 75a and 75b determine the widthwise dimension and widthwise position of a separator original sheet 12b and that the reading section 73, on the basis of (i) the widthwise position of a defect D present in the separator original sheet 12b and (ii) the widthwise position or widthwise dimension of the separator original sheet 12b, identifies which of a plurality of heat-resistant separators 12a prepared by slitting the separator original sheet 12b has the defect D present therein. The separator producing method and separator producing apparatus of the present, invention are not limited to the above.

<Cutter Adjusting Step>

Embodiment 3 includes (i) determining the widthwise dimension and widthwise position of a separator original sheet 12b and (ii) in a slitting step, adjusting the position of each cutting device 7 (that is, the position of the blade 72 of each cutting device 7) included in the slitting apparatus 6 on the basis of the widthwise position or widthwise dimension of the separator original sheet 12b (cutter adjusting step). Any constituent element of Embodiment 3 that is identical to a corresponding constituent element described earlier for Embodiment 1 or 2 is assigned a common reference sign, and is not described in detail here.

Specifically the cutter adjusting step moves the cutting devices 7 in a direction orthogonal to the conveying direction so that the separator original sheet 12b is slit along intended, appropriate slit lines. The cutter adjusting step may move the cutting devices 7 in the same direction in such a manner that the intervals between the cutting devices 7 are unchanged or in such a manner that the intervals between the cutting devices 7 are changed.

Carrying out the cutter adjusting step ensures that the separator original sheet 12b is slit at intended slit positions in the slitting step, which in turn makes it possible to produce a heat-resistant separator 12a having an appropriate dimension (product width). Further, since the cutter adjusting step allows a separator original sheet 12b to be slit at intended slit positions in the slitting step, Embodiment 3 also facilitates identifying which of a plurality of heat-resistant separators 12a has a defect present therein.

<Conveyance Adjusting Step>

Embodiment 3 may include (i) determining the widthwise dimension and widthwise position of a separator original sheet 12b and (ii) in the slitting step, the conveying section 76b adjusting the widthwise position or conveyance tension of the separator original sheet 12b being conveyed (conveyance adjusting step).

Specifically, the conveyance adjusting step moves the separator original sheet 12b in a direction (transverse direction or TD) orthogonal to the conveying direction or changes the conveyance tension of the separator original sheet 12b so that the separator original sheet 12b is slit at intended slit positions.

Carrying out the cutter adjusting step ensures that the separator original sheet 12b is slit at intended slit positions in the slitting step, which in turn makes it possible to produce a heat-resistant separator 12a having an appropriate dimension (product width). Further, since the cutter adjusting step allows a separator original sheet 12b to be slit at intended slit positions in the slitting step. Embodiment 3 also facilitates identifying which of a plurality of heat-resistant separators 12a has a defect present therein.

[Software Implementation Example]

The reading section 73, the defect information recording device 56 or 56a, and the information storing device 91 can be realized by a logic circuit (hardware) provided in an integrated circuit. (IC chip) or the like or can be alternatively realized by software as executed by a central processing unit (CPU).

In the latter case, the reading section 73, the defect information recording device 56 or 56a, and the information storing device 91 each include: a CPU that executes instructions of a program that is software realizing the foregoing functions; a read only memory (ROM) or a storage device (each referred to as “storage medium”) storing the program and various kinds of data in such a form that they are readable by a computer (or a CPU); and a random access memory (RAM) that develops the program in executable form. The object of the present, invention can be achieved by a computer (or a CPU) reading and executing the program stored in the storage medium. The storage medium may be “a non-transitory tangible medium” such as a tape, a disk, a card, a semiconductor memory, and a programmable logic circuit. Further, the program may be made available to the computer via any transmission medium (such as a communication network and a broadcast wave) which enables transmission of the program. The present invention may further be in the form of a data signal embedded in a carrier wave and embodied by electronic transmission of the programs.

The above embodiments of the present invention are each an example involving a separator. The present invention is, however, not limited to production of a separator, and may also be applied to production of other films and film original sheets. A separator, which is a porous film and is thus flexible, tends to meander and expand or contract under tension through a conveying mechanism. The present invention is therefore suitably applicable to a method for producing a separator in particular.

[Main Points]

In order to solve the above problem, a film producing method in accordance with the present embodiment is a film producing method, including: a slitting step of slitting a film original sheet lengthwise, the film original sheet being conveyed lengthwise, to form a plurality of films, the slitting step including a determining step of determining a widthwise dimension or a widthwise position of the film original sheet being conveyed.

The above production method makes it possible to determine the widthwise dimension and widthwise position of a film original sheet conveyed in the slitting step. This allows a position on a film original sheet to correspond accurately to a film.

The film producing method in accordance with the present embodiment may further include: a defect detecting step of detecting a position of a defect in the film original sheet; and an identifying step of identifying, on a basis of (i) the position of the defect, the position having been detected in the defect detecting step, and (ii) the widthwise dimension or the widthwise position of the film original sheet, the widthwise dimension or the widthwise position having been determined in the determining step, which of the plurality of films has the defect.

The above production method makes it possible to identify a film having a defect present therein, on the basis of (i) the position of the defect which position has been detected in the defect detecting step and (ii) the widthwise dimension or widthwise position of the film original sheet which widthwise dimension or widthwise position has been determined in the determining step included in the slitting step.

The above configuration makes it possible to accurately identify a film having a defect present therein, even in the case where the respective positions of slit lines for the film original sheet have been displaced from the preset, positions as a result of (i) the difference between the tension applied to the film original sheet conveyed in the slitting step and the intended tension or (ii) the difference, caused by meandering and/or deformation of the film original sheet conveyed in the slitting step, between the position of the film original sheet and its intended position.

The film producing method in accordance with the present embodiment may be arranged such that the identifying step includes identifying, on a basis of a slitting position for the film original sheet, which of the plurality of films has the defect. The closer the detected position, of the defect in the film original sheet is to any intended slitting position for the film original sheet, the higher the risk of a wrong film being erroneously identified as the film having the defect present therein.

In view of that, the above production method, which identifies a film having a defect present therein on the basis of the slitting positions for the film original sheet, makes it possible to accurately identify such a film having a defect present therein.

The film producing method in accordance with the present embodiment may be arranged such that the defect detecting step includes detecting the position of the defect in the film original sheet being conveyed by a first conveying mechanism; and the determining step includes determining the widthwise dimension or the widthwise position of the film original sheet being conveyed by a second conveying mechanism, which is different from the first conveying mechanism.

Different conveying mechanisms may apply different tensions to a film original sheet. The above production method makes it possible to, in a case where different tensions are applied in the defect detecting step and the determining step, recognize a change of the widthwise dimension or widthwise position caused by the difference in tension.

The film producing method in accordance with the present embodiment may be arranged such that the determining step includes determining a widthwise displacement of the film original sheet with respect to a widthwise position of the film original sheet in the defect detecting step.

The above production method makes it possible to accurately identify a film having a defect present therein, even in the case where the film original sheet has been displaced widthwise in the determining step with respect to the widthwise position of the film original sheet in the defect detecting step.

The film producing method in accordance with the present embodiment may be arranged such that the determining step includes determining a widthwise expansion or a widthwise contraction of the film original sheet with respect to a widthwise dimension of the film original sheet in the defect detecting step.

The above production method makes it possible to accurately identify a film having a defect present therein, even in the case where the widthwise dimension of the film original sheet has been changed in the determining step with respect to the widthwise dimension of the film original sheet in the defect detecting step.

The film producing method in accordance with the present embodiment may be arranged such that the slitting step includes slitting the film original sheet along a slit line extending in a conveying direction through a cutter position; and the slitting step includes a cutter adjusting step of adjusting the cutter position on a basis of the widthwise dimension or the widthwise position of the film original sheet, the widthwise dimension or the widthwise position having been determined in the determining step.

The above production method makes it possible to adjust cutter positions on the basis of the widthwise dimension or widthwise position of the film original sheet which widthwise dimension or widthwise position has been determined in the determining step and to then slit the film original sheet.

The above configuration makes it possible to slit a film original sheet at appropriately adjusted cutter positions, and facilitates identifying which of a plurality of films has a defect present therein.

The film producing method in accordance with the present embodiment may be arranged such that the slitting step includes slitting the film original sheet along a slit line extending in a conveying direction through a cutter position; and the slitting step includes a conveyance adjusting step of adjusting, on a basis of the widthwise dimension or the widthwise position of the film original sheet, the widthwise dimension or the widthwise position having been determined in the determining step, the widthwise position or a conveyance tension of the film original sheet being conveyed.

The above production method makes it possible to adjust the widthwise position or conveyance tension of the film original sheet on the basis of the widthwise dimension or widthwise position of the film original sheet which widthwise dimension or widthwise position has been determined in the determining step and to then slit the film original sheet.

The above configuration makes it possible to slit a film original sheet along appropriately set slit lines, and facilitates identifying which of a plurality of films has a defect present therein.

The film producing method in accordance with the present embodiment may be arranged such that the defect detecting step includes providing the film original sheet with a defect code indicative of information including information on the position of the defect, the position having been detected in the defect detecting step; the slitting step includes a defect code reading step of reading the defect code provided in the defect detecting step; and the identifying step includes identifying, on a basis of (i) the position of the defect, the position being indicated by the defect code read in the defect code reading step, and (ii) the widthwise dimension or the widthwise position of the film original sheet, the widthwise dimension or the widthwise position having been determined in the determining step, which of the plurality of films has the defect.

The above production method makes it possible to separately carry out the determining step, which is a step of determining the widthwise dimension or widthwise position of a film original sheet, and a defect code reading step of reading a defect code. This improves reliability of the determination and defect code reading over a configuration of carrying out the two steps simultaneously.

The film producing method in accordance with the present embodiment may be arranged such that the determining step includes detecting a position of a widthwise end of the film original sheet and reading a defect code on the film original sheet, the defect code being indicative of information including information on a position of a defect in the film original sheet.

The above production method makes it possible to both detect the position of a widthwise end of a film original sheet and read a defect code in the determining step. This can simplify the production process.

In order to solve the above problem, a film producing apparatus in accordance with the present embodiment is a film producing apparatus, including a cutting section configured to slit a film original sheet lengthwise, the film original sheet being conveyed lengthwise, to form a plurality films, the cutting section including a determining section configured to determine a widthwise dimension and a widthwise position of the film original sheet being conveyed to the cutting section.

The above production apparatus makes if possible to determine the widthwise dimension or widthwise position of a film original sheet being conveyed. This allows a position on a film original sheet to correspond accurately to a film.

The film producing apparatus in accordance with the present embodiment may further include a defect detecting section configured to detect a position of a defect in the film original sheet; and an identifying section configured to identify, on a basis of (i) the position of the defect, the position having been detected by the defect detecting section, and (ii) the widthwise dimension or the widthwise position of the film original sheet, the widthwise dimension or the widthwise position having been determined by the determining section, which of the plurality of films has the defect, wherein: the defect detecting section provides the film original sheet with a defect code indicative of information including information on the position of the defect, the position having been detected by the defect detecting section; the cutting section includes a defect code reading section configured to read the defect code provided by the defect detecting section; and the identifying section identifies, on a basis of (i) the position of the defect, the position being indicated by the defect code read by the defect code reading section, and (ii) the widthwise dimension or the widthwise position of the film original sheet, the widthwise dimension or the widthwise position having been determined by the determining section, which of the plurality of films has the defect.

The above production apparatus separately includes the determining section, which is a section configured to determine the widthwise dimension or widthwise position of a film original sheet, and a defect code reading section configured to read a defect code. This improves reliability of the determination and defect code reading over a configuration of a single section carrying out the two operations.

The film producing apparatus in accordance with the present embodiment may be arranged such that the determining section detects a position of a widthwise end of the film original sheet and reads a defect code on the film original sheet, the defect code being indicative of information including information on a position of a defect in the film original sheet.

The above production apparatus includes a determining section that doubles as a defect code reading section. This can simplify equipment necessary for the production process.

The film producing apparatus in accordance with the present embodiment may further include a defect detecting section configured to detect a position of a defect in the film original sheet, wherein: the defect detecting section detects the position of the defect in the film original sheet being conveyed by a first conveying mechanism; and the determining section determines the widthwise dimension or the widthwise position of the film original sheet being conveyed by a second conveying mechanism, which is different from the first conveying mechanism.

The above production apparatus can, even in a case where a film original sheet is conveyed by different conveying mechanisms in the defect detecting step and the slitting step, specify the position of a defect present in the film original sheet and determine the widthwise dimension or widthwise position of the film original sheet.

The present invention is not limited to the description of the embodiments above, but may be altered in various ways by a skilled person within the scope of the claims. Any embodiment based on a proper combination of technical means disclosed in different embodiments is also encompassed in the technical scope of the present invention.

### REFERENCE SIGNS LIST

4 heat-resistant layer

6 slitting apparatus

7 cutting device (cutting section)

12 separator

12a heat-resistant separator (separator, film)

12b heat-resistant separator original sheet (separator original sheet, film original sheet)

12c separator original sheet

54 coating section

55 base material defect inspecting device (defect detecting section, separator producing apparatus)

57 coating defect inspecting device (defect detecting section, separator producing apparatus)

58 pinhole defect inspecting device (defect detecting section, separator producing apparatus)

56, 56a defect information recording device

73, 73a reading section (identifying section, determining section)

74 mark providing device

75a, 75b detection camera (determining section, defect code reading section)

76a conveying mechanism (first conveying mechanism)

76b conveying section (second conveying mechanism)

77 slitting section

81, 82 core

83 mark sensing device

84 defect removing device

85 connecting device

86 outermost portion

91 information storing device

D defect

DC, DC2 defect code (positional information)

L mark

1. A film producing method, comprising:
a slitting step of slitting a film original sheet lengthwise, the film original sheet being conveyed lengthwise, to form a plurality of films,
the slitting step including a determining step of determining a widthwise dimension or a widthwise position of the film original sheet being conveyed.

2. The film, producing method according to claim 1, further comprising:
a defect detecting step of detecting a position of a defect in the film original sheet; and
an identifying step of identifying, on a basis of (i) the position of the defect, the position having been detected in the defect detecting step, and (ii) the widthwise dimension or the widthwise position of the film original sheet, the widthwise dimension or the widthwise position having been determined in the determining step, which of the plurality of films has the defect.

3. The film producing method according to claim 2,
wherein
the identifying step includes identifying, on a basis of a slitting position for the film original sheet, which of the plurality of films has the defect.

4. The film producing method according to claim 2,
wherein:
the defect detecting step includes detecting the position of the defect in the film original sheet being conveyed by a first conveying mechanism; and
the determining step includes determining the widthwise dimension or the widthwise position of the film original sheet being conveyed by a second conveying mechanism, which is different from the first conveying mechanism.

5. The film producing method according to claim 2,
wherein
the determining step includes determining a widthwise displacement of the film original sheet with respect to a widthwise position of the film original sheet in the defect detecting step.

6. The film producing method according to claim 2,
wherein
the determining step includes determining a widthwise expansion or a widthwise contraction of the film original sheet with respect to a widthwise dimension of the film original sheet in the defect detecting step.

7. The film producing method according to claim 1,
wherein:
the slitting step includes slitting the film original sheet along a slit line extending in a conveying direction through a cutter position; and
the slitting step includes a cutter adjusting step of adjusting the cutter position on a basis of the widthwise dimension or the widthwise position of the film original sheet, the widthwise dimension or the widthwise position having been determined in the determining step.

8. The film producing method according to claim 1,
wherein:
the slitting step includes slitting the film original sheet along a slit line extending in a conveying direction through a cutter position; and
the slitting step includes a conveyance adjusting step of adjusting, on a basis of the widthwise dimension or the widthwise position of the film original sheet, the widthwise dimension or the widthwise position having been determined in the determining step, the widthwise position or a conveyance tension of the film original sheet being conveyed.

9. The film producing method according to claim 2,
wherein:
the defect detecting step includes providing the film original sheet with a defect code indicative of information including information on the position of the defect, the position having been detected in the defect detecting step;
the slitting step includes a defect code reading step of reading the defect code provided in the defect detecting step; and
the identifying step includes identifying, on a basis of (i) the position of the defect, the position being indicated by the defect code read in the defect code reading step, and (ii) the widthwise dimension or the widthwise position of the film original sheet, the widthwise dimension or the widthwise position having been determined in the determining step, which of the plurality of films has the defect.

10. The film producing method according to claim 1,
wherein
the determining step includes detecting a position of a widthwise end of the film original sheet and reading a defect code on the film original sheet, the defect code being indicative of information including information on a position of a defect in the film original sheet.

11. A film producing apparatus comprising
a cutting section configured to slit a film original sheet lengthwise, the film original sheet being conveyed lengthwise, to form a plurality films,
the cutting section including a determining section configured to determine a widthwise dimension and a widthwise position of the film original sheet being conveyed to the cutting section.

12. The film producing apparatus according to claim 11, further comprising:
a defect detecting section configured to detect a position of a defect in the film original sheet; and
an identifying section configured to identify, on a basis of (i) the position of the defect, the position having been detected by the defect detecting section, and (ii) the widthwise dimension or the widthwise position of the film original sheet, the widthwise dimension or the widthwise position having been determined by the determining section, which of the plurality of films has the defect,
wherein:
the defect detecting section provides the film original sheet with a defect code indicative of information including information on the position of the defect, the position having been detected by the defect detecting section;
the cutting section includes a defect code reading section configured to read the defect code provided by the defect detecting section; and
the identifying section identifies, on a basis of (i) the position of the defect, the position being indicated by the defect code read by the defect, code reading section, and (ii) the widthwise dimension or the widthwise position of the film original sheet, the widthwise dimension or the widthwise position having been determined by the determining section, which of the plurality of films has the defect.

13. The film producing apparatus according to claim 11,
wherein
the determining section detects a position of a widthwise end of the film original sheet and reads a defect code on the film original sheet, the defect code being indicative of information including information on a position of a defect in the film original sheet.

14. The film producing apparatus according to claim 11, further comprising
a defect detecting section configured to detect a position of a defect in the film original sheet,
wherein:
the defect detecting section detects the position of the defect in the film original sheet being conveyed by a first conveying mechanism; and
the determining section determines the widthwise dimension or the widthwise position of the film original sheet being conveyed by a second conveying mechanism, which is different from the first conveying mechanism.
